(19) United States
(12) Patent Application Publication
(10) Pub. No.: US 2018/0266784 A1
(43) Pub. Date: Sep. 20, 2018

(54) SOLID-STATE GENERATOR FOR FIREARM

(71) Applicant: Jeffrey Malcolm GUY, Burlington (CA)

(72) Inventor: Jeffrey Malcolm GUY, Burlington (CA)

(21) Appl. No.: 15/790,167

(22) Filed: Oct. 23, 2017

Related U.S. Application Data
(60) Provisional application No. 62/471,925, filed on Mar. 15, 2017.

(51) Int. Cl. F41A 35/00

(52) U.S. Cl. CPC F41A 35/00; F21L 13/02

(57) ABSTRACT

An apparatus includes a solid-state generator for a firearm. The firearm is configured to support a firearm accessory. The solid-state generator is configured to be electrically coupled to the firearm accessory. The firearm accessory is configured to be electrically powered. The solid-state generator is also configured to convert, at least in part, waste energy generated, at least in part, by the discharge of the firearm into electricity in such a way that the solid-state generator, in use, provides, at least in part, the electricity to be consumed, at least in part, by the firearm accessory of the firearm.

### TECHNICAL FIELD

This document relates to the technical field of (and is not limited to) a solid-state generator for a firearm, and/or a solid-state generator configured to generate electricity from the discharge of a firearm (and method therefor).

### BACKGROUND

The modern soldier has come to rely on a variety of electronic devices designed for communication, navigation, targeting, illumination and an ever-growing array of other purposes. These devices improve the safety and efficiency of the soldier as well as enabling improved communication between soldiers or between a soldier and command.

An embodiment of a firearm accessory may include a tactical light, which is a light source utilized in conjunction with (mounted to) a firearm (a weapon). The firearm accessory (such as the tactical light) is powered by a battery assembly. The light (also called a light source, such as, a tactical light, etc. and any equivalent thereof) is configured to aid the identification of a low-light target, and allow the user of the firearm (such as a marksman, a law enforcement officer or a soldier, etc.) to simultaneously aim the firearm and illuminate the target. The tactical light may be mounted to the firearm with the tactical light emitting a light beam aligned parallel to the bore of the firearm. The tactical light may be used to temporarily blind and/or disorient targets. Another embodiment of the firearm accessory may include a sighting laser, a camera, a heated grip, an illuminated sight or any other device that is configured to be battery operated.

### SUMMARY

It will be appreciated that there exists a need to mitigate (at least in part) at least one problem associated with the existing firearms and/or existing firearm accessories (also called the existing technology). After much study of the known systems and methods with experimentation, an understanding of the problem and its solution has been identified and is articulated as follows:

The run time of these known electronic devices (utilized by soldiers or a firearm user, etc.) is limited by the useful life of the batteries carried by the user. For instance, in active combat situations the batteries are often replaced before the end of their useful life due to the concern of battery failure in a hazardous or life-threatening situation. It may be advantageous, both in run time and the weight of the power source, for the case where these power sources could be self-regenerating.

Electrically-operated firearm accessories are known, such as laser-aiming devices, electronic sights, and/or illumination devices, etc.

The firearm accessory requires a battery (a storage of electricity), whether rechargeable or replaceable. Regardless of the type of electricity storage, the operating time of the firearm accessory is limited by the electrical capacity of the battery, and the battery needs to be replaced, or recharged, when its electrical capacity is sufficiently diminished. This situation may be inconvenient, from time to time, for the user of the firearm for the case where the user may be located in a remote location where a replacement battery, or a power source for charging the battery, may be difficult or dangerous to obtain or utilize.

It is noted that there is an amount of excess energy that is wasted (not utilized) for the case where a firearm is discharged. The wasted energy is lost (or emitted by the firearm) as a combination thermal waste energy and kinetic waste energy (such as, in the form of firearm recoil and a shockwave of expanding combustion gasses).

In some types of firearms, a relatively small fraction of the wasted energy is utilized to cycle the firearm action (some of the wasted energy is stored in compressed springs to ready for the firing of the next shot from the firearm). While this may be an efficient process, it uses a relatively small portion of the available waste energy generated or created by the firearm (thereby leaving the majority of the remainder of waste energy not utilized, but may be available for conversion into electrical energy and provided for storage in the battery associated with the firearm accessory, etc.).

Upon discharging the firearm, the stored chemical potential energy in the propellant of a cartridge (ammunition) is rapidly converted into kinetic energy and thermal energy. The majority of the kinetic energy in the form of expanding gasses is utilized to propel the projectile from the barrel of the firearm. However, a significant portion of the wasted energy is directed rearwards and may be experienced as firearm recoil. The wasted heat energy, from the rapid combustion of the propellant, is absorbed (at least in part) by the barrel and pressure bearing components of the firearm, and is then dissipated into the adjacent atmosphere. This thermal energy is entirely wasted, and may build-up the barrel temperature high enough to be detrimental to the metal components of the firearm, etc. Therefore, it may be beneficial to utilize (and therefore dissipate) the wasted energy associated with the discharging of the firearm.

In accordance with a first preferred embodiment, a solution provides an apparatus configured to consume and dissipate waste energy (heat) from the firearm, and to utilize the waste energy for generating electricity that may be utilized by the firearm accessory, or stored in the battery of the firearm accessory.

In accordance with a second preferred embodiment, a solution may provide an apparatus configured to dissipate (consume) waste heat generated as a result of the discharging of the firearm, preferably through a heat sink assembly, while using the heat transfer (associated with the waste energy) to generate electricity, such as a voltage difference between dissimilar semiconductors configured as a thermoelectric generator, in what is known as the Seebeck effect. In accordance with an embodiment, the solid-state generator includes a thermoelectric device having (comprised of) dissimilar semiconductors.

In accordance with a third preferred embodiment, a solution may provide an apparatus configured to (A) convert (at least in part) a portion of the waste energy (generated by the discharging of the firearm) into electricity, and (B) store the converted energy in a battery (or any equivalent thereof, such as a capacitor, etc.).

In accordance with a fourth preferred embodiment, a solution may provide an apparatus configured to utilize a temperature difference between the firearm and the adjacent atmosphere to convert the thermal waste energy (associated with the discharging of the firearm) into electricity.

In accordance with a sixth preferred embodiment, a solution may provide an apparatus configured to be integrated with the firearm accessory (a light source, a laser source, etc.).

In accordance with a seventh preferred embodiment, a solution may provide an apparatus configured to generate electricity that may be provided to power a stand-alone device, such as a retrofit to the firearm accessory, such as a third-party laser sight or an illuminated optic, etc. The additional electricity may be used to increase the run time (operating time) of the firearm accessory, and/or provide a reliable power source (electrical generating source) configured to generate electricity as the firearm is utilized (discharged).

In accordance with an eighth preferred embodiment, a solution provides an apparatus including (and not limited to) a piezo-and-pyro electric generator configured to generate electricity in response to physical stimulus in the form of the heat and/or pressure spike associated with the combustion of the ammunition propellant. A housing assembly (also called a body assembly) is configured to receive and support the piezo-and-pyro electric generator. The housing assembly is also configured to be affixed to (and/or removable from) the firearm from which the ammunition propellant was discharged (released).

To mitigate, at least in part, at least one problem associated with the existing technology, there is provided (in accordance with a first major aspect) an apparatus. The apparatus includes and is not limited to (comprises) a solid-state generator. The solid-state generator is for utilization with the firearm. The firearm may include (and is not limited to) a handgun, a portable gun, a rifle, a machine gun, a cannon, a weapon, etc., and any equivalent thereof. The firearm is configured to support (or to be used with) a firearm accessory (such as, a flash light assembly, etc.). The firearm accessory is configured to be electrically powered. In accordance with an option, the solid-state generator is configured to be coupled (either directly or indirectly) to the firearm. In accordance with another option, the solid-state generator is configured to be integral to the firearm. The solid-state generator is also configured to be electrically coupled (either directly or indirectly) to the firearm accessory. The solid-state generator is also configured to convert, at least in part, waste energy generated, at least in part, by the discharge of the firearm into electricity. This is done in such a way that the solid-state generator, in use, provides (either directly or indirectly), at least in part, the electricity to be consumed, at least in part, by the firearm accessory of the firearm.

To mitigate, at least in part, at least one problem associated with the existing technology, there is provided (in accordance with a second major aspect) an apparatus. The apparatus includes and is not limited to (comprises) a synergistic combination of a firearm and a solid-state generator. The firearm is configured to support the firearm accessory. The solid-state generator is configured to be coupled to, or to be integral to, the firearm. The solid-state generator is also configured to be electrically coupled (either directly or indirectly) to the firearm accessory. The firearm accessory is configured to be electrically powered. The solid-state generator is also configured to convert, at least in part, waste energy generated, at least in part, by the discharge of the firearm into electricity. This is done in such a way that the solid-state generator, in use, provides (either directly or indirectly), at least in part, the electricity to be consumed, at least in part, by the firearm accessory of the firearm.

To mitigate, at least in part, at least one problem associated with the existing technology, there is provided (in accordance with a third major aspect) an apparatus. The apparatus includes and is not limited to (comprises) a synergistic combination of a firearm and a firearm accessory. The firearm accessory is configured to be supported by the firearm. The solid-state generator is configured to be coupled to, or to be integral to, the firearm. The solid-state generator is also configured to be electrically coupled (either directly or indirectly) to the firearm accessory. The firearm accessory is configured to be electrically powered. The solid-state generator is also configured to convert, at least in part, waste energy generated, at least in part, by the discharge of the firearm into electricity. This is done in such a way that the solid-state generator, in use, provides (either directly or indirectly), at least in part, the electricity to be consumed, at least in part, by the firearm accessory of the firearm.

To mitigate, at least in part, at least one problem associated with the existing technology, there is provided (in accordance with a fourth major aspect) a method. The method is for operating a firearm accessory of a firearm. The method includes and is not limited to (comprises) (A) converting, at least in part, waste energy generated, at least in part, by the discharge of the firearm into electricity; and (B) providing, at least in part, the electricity to be consumed, at least in part, by the firearm accessory of the firearm.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a schematic view of a method of utilizing the waste energy (associated with the discharging of a firearm) by an solid-state generator, in which the embodiments of the solid-state generator are depicted in the embodiment depicted in FIG. 2A, FIG. 2B, and FIG. 3 to FIG. 9; and

FIG. 2A and FIG. 2B depicts a side view (FIG. 2A) and a schematic view of operations (FIG. 2B) of embodiments of the solid-state generator and a firearm; and

FIG. 3 depicts a close-up of a side view of an embodiment of the solid-state generator of FIG. 2A; and

FIG. 4 depicts a cross-sectional view of an embodiment of the solid-state generator of FIG. 2A; and

FIG. 5 depicts a perspective view of an embodiment of the solid-state generator of FIG. 2A; and

FIG. 6 depicts an end view of an embodiment of the solid-state generator of FIG. 2A; and

FIG. 7 depicts a side view of an embodiment of the solid-state generator, and an embodiment of the firearm of FIG. 2A; and

FIG. 8 depicts a close-up of a perspective view of an embodiment of the solid-state generator of FIG. 7; and

FIG. 9 depicts a cross-sectional view of an embodiment of the solid-state generator of FIG. 7.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus

102 solid-state generator

103 body assembly

105 thermally-conductive mating surface

110 clamp assembly

111 clamp element

200 thermoelectric device

202 heat sink assembly

212 interior passageway

213 protective enclosure

215 handle

300 piezo-and-pyro electric device

400 method

402 first operation

404 second operation

1800 flow diagram

900 firearm

902 firearm accessory

903 energy storage device

904 barrel assembly

906 accessory rail

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after the filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

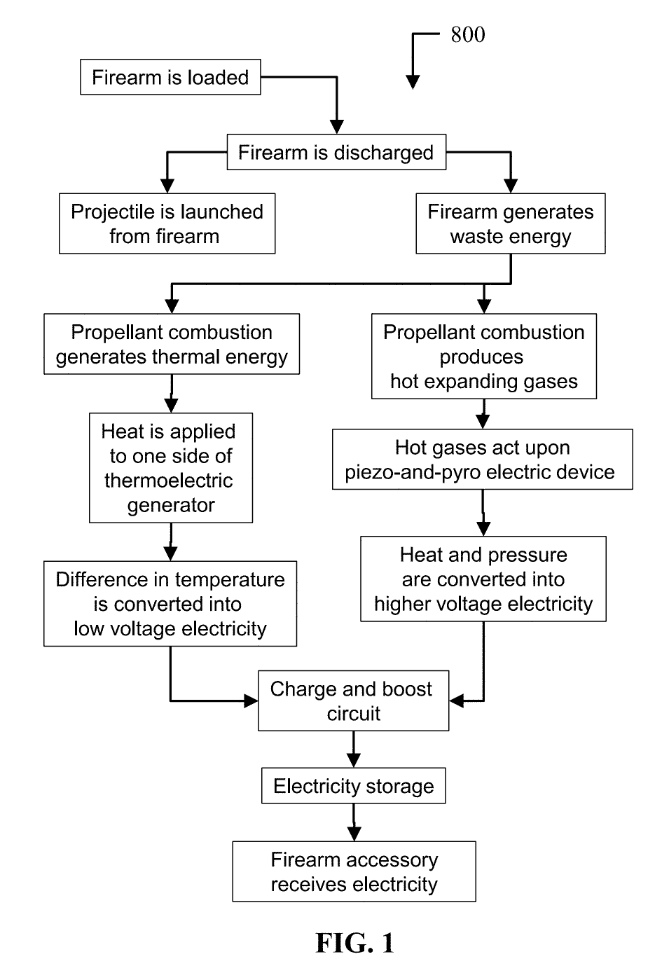

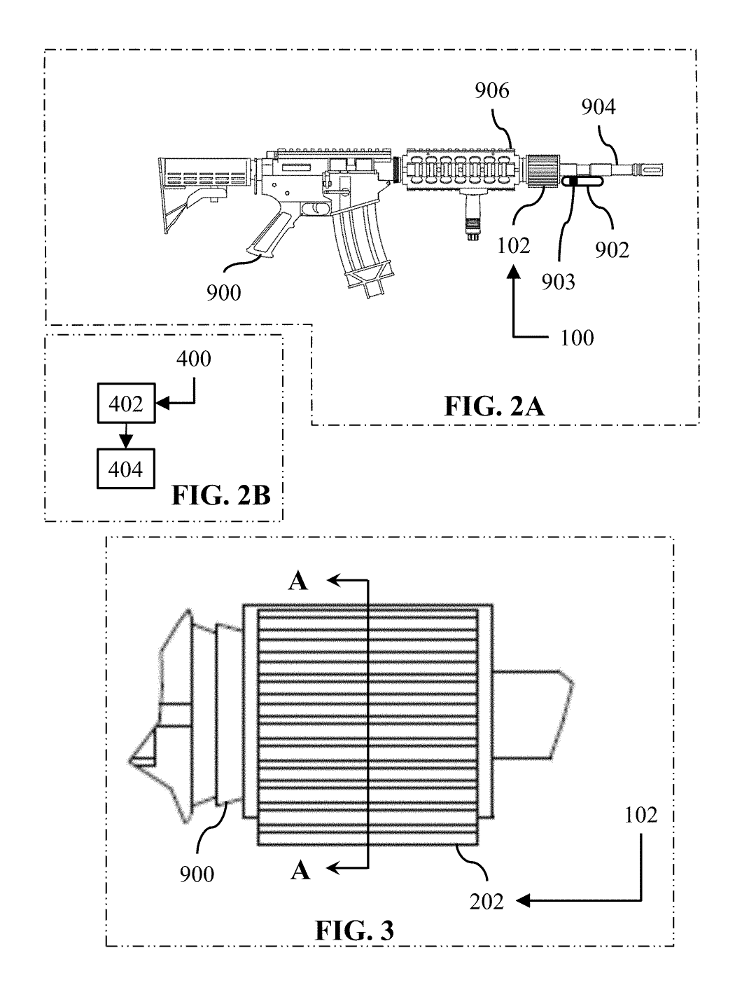

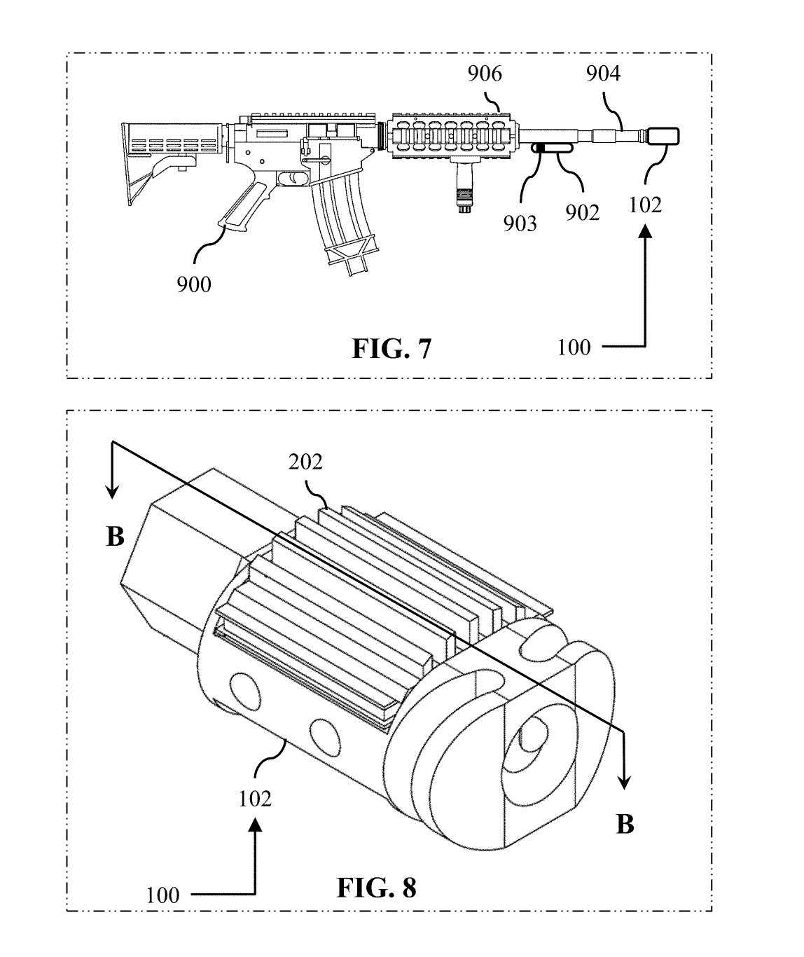

FIG. 1 depicts a schematic view of a method of utilizing the waste energy (associated with the discharging of a firearm 900) by a solid-state generator 102, in which the embodiments of the solid-state generator 102 are depicted in the embodiments of FIG. 2A, FIG. 2B, FIG. 3-FIG. 9, and in which the firearm 900 is depicted in the embodiments of FIG. 2A or FIG. 7). The solid-state generator 102 is a device configured to generate an electrical charge in response to a physical change in the environment (associated with the discharging of the firearm 900). The physical change includes, and is not limited to, a temperature change, a shock wave, a load (a force), a pressure, other physical stimulus (effect), and any equivalent thereof. The solid-state generator 102 has no mobile (movable) parts. The solid-state generator 102 does not include a transducer or an actuator (which reacts depending on an electrical stimulus). For instance, the solid-state generator 102 is constructed of one or more solid materials, and in which the electrons, or other charge carriers, are confined entirely within the solid material (such as a semiconductor), etc., and any equivalent thereof. The solid-state generator 102 may include a crystalline solid, a polycrystalline solid, an amorphous solid, and/or a crystalline semiconductor.

Referring to the embodiment as depicted in FIG. 1, a flow diagram 800 depicts embodiments of the waste energy generated by the discharging of the firearm 900 (which is depicted in the embodiments of FIG. 2A or FIG. 7). Depending on the application of the solid-state generator 102, the solid-state generator 102 may implement any one or both paths of the flow diagram 800.

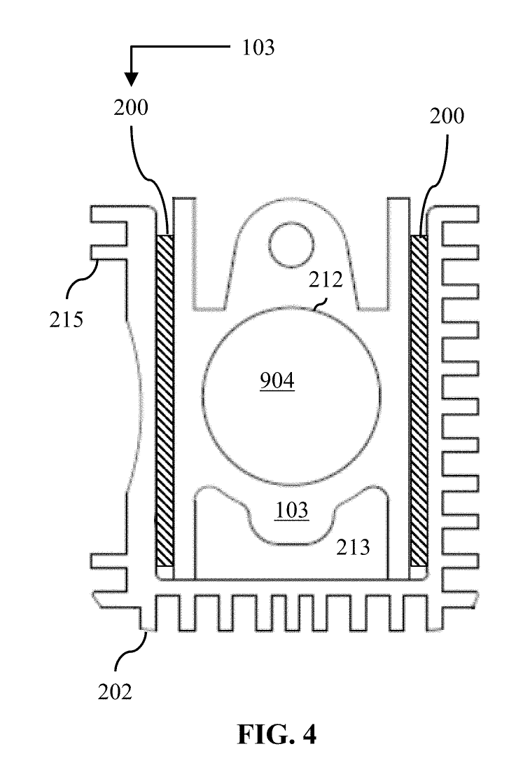

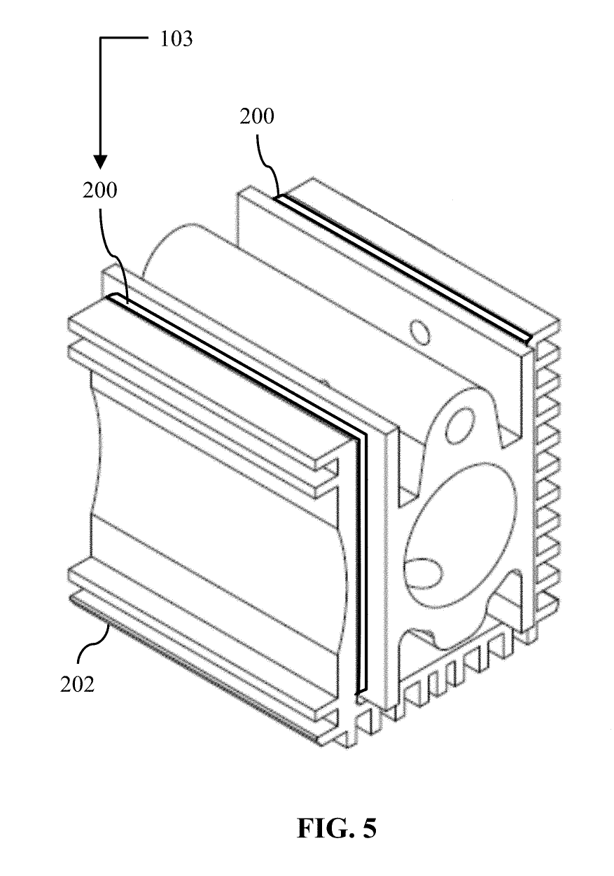

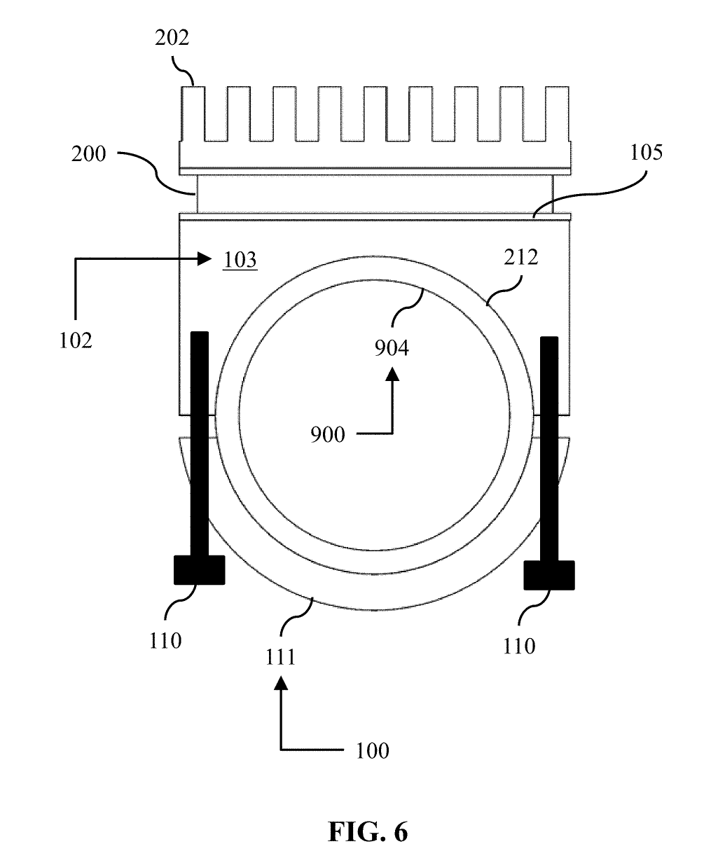

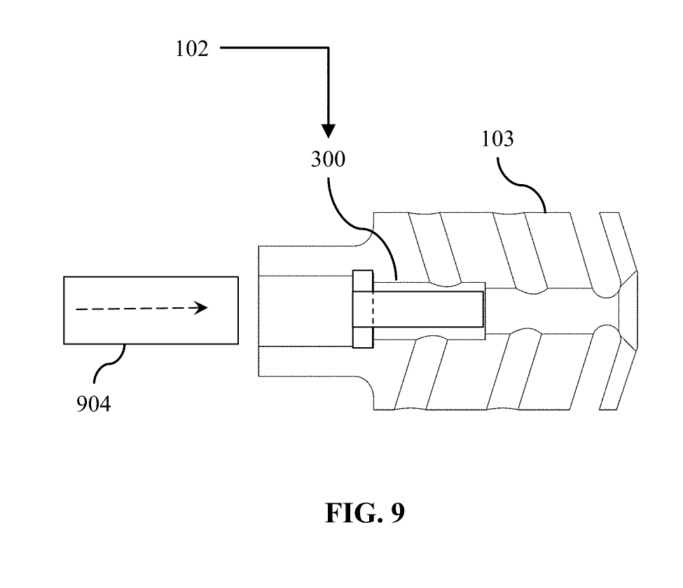

FIG. 2A, FIG. 2B, and FIG. 3 to FIG. 9 depict views of the embodiments of a solid-state generator 102. FIG. 2A depicts a side view, FIG. 2B depicts a schematic view of operations, FIG. 3 depicts a close-up of a side view, FIG. 4 depicts a cross-sectional view, FIG. 5 depicts a perspective view, FIG. 6 depicts an end view, FIG. 7 depicts a side view, FIG. 8 depicts a close-up of a perspective view, and FIG. 9 depicts a cross-sectional view.

With reference to FIG. 2A, FIG. 2B, and FIG. 3 to FIG. 9, and in accordance with a first major embodiment, there is provided an apparatus 100. The apparatus 100 includes and is not limited to (comprises) the solid-state generator 102. The solid-state generator 102 is for utilization with the firearm 900. The firearm 900 may include (and is not limited to) a handgun, a portable gun, a rifle, a machine gun, a cannon, a weapon, etc., and any equivalent thereof. The firearm 900 may include a barreled weapon. The firearm 900 is configured to launch ammunition (one or more projectiles, such as a bullet, etc.) driven by the action of an explosive force caused by the generation of pressure during the discharge of the ammunition (such as, the explosive force generated by a propellant). The firearm 900 is configured to support (or to be used with) a firearm accessory 902 (such as, a flash light assembly, etc.). The firearm accessory 902 is configured to be electrically powered.

In accordance with an option, the solid-state generator 102 is configured to be coupled to (either directly or indirectly) the firearm 900. In accordance with another option, the solid-state generator 102 is configured to be integral to the firearm 900. The solid-state generator 102 is also configured to be electrically coupled to (either directly or indirectly) the firearm accessory 902. The solid-state generator 102 is also configured to convert (either directly or indirectly), at least in part, waste energy generated, at least in part, by the discharge of the firearm 900 into electricity. This is done in such a way that the solid-state generator 102, in use, provides (either directly or indirectly), at least in part, the electricity to be consumed, at least in part, by the firearm accessory 902 of the firearm 900.

With reference to FIG. 2A, FIG. 2B, and FIG. 3 to FIG. 9, and in accordance with a second major embodiment, there is provided an apparatus 100, in which the apparatus 100 includes and is not limited to (comprises) a synergistic combination of a firearm 900 and an solid-state generator 102. The firearm 900 is configured to support the firearm accessory 902. The solid-state generator 102 is configured to be coupled to, or to be integral to, (either directly or indirectly) the firearm 900. The solid-state generator 102 is also configured to be electrically coupled to (either directly or indirectly) the firearm accessory 902. The firearm accessory 902 is configured to be electrically powered. The solid-state generator 102 is also configured to convert (either directly or indirectly), at least in part, waste energy generated, at least in part, by the discharge of the firearm 900 into electricity in such a way that the solid-state generator 102, in use, provides (either directly or indirectly), at least in part, the electricity to be consumed, at least in part, by the firearm accessory 902 of the firearm 900.

With reference to FIG. 2A, FIG. 2B, and FIG. 3 to FIG. 9, and in accordance with a third major embodiment, there is provided an apparatus 100, in which the apparatus 100 includes and is not limited to (comprises) a synergistic combination of a firearm 900, a firearm accessory 902. The firearm accessory 902 is configured to be supported by the firearm 900. The solid-state generator 102 is configured to be coupled to, or to be integral to, (either directly or indirectly) the firearm 900. The solid-state generator 102 is also configured to be electrically coupled to (either directly or indirectly) the firearm accessory 902. The firearm accessory 902 is configured to be electrically powered. The solid-state generator 102 is also configured to convert (either directly or indirectly), at least in part, waste energy generated by the discharge of the firearm 900 into electricity in such a way that the solid-state generator 102, in use, provides at least in part, the electricity to be consumed, at least in part, by the firearm accessory 902 of the firearm 900.

With reference to the embodiment as depicted in FIG. 2B, and in accordance with a fourth major embodiment, there is provided a method 400, in which the method 400 is for operating a firearm accessory 902 of a firearm 900. The method 400 includes and is not limited to (comprises) (A) a first operation 402 including converting, at least in part, waste energy generated, at least in part, by the discharge of the firearm 900 into electricity, and (B) a second operation 404 including providing, at least in part, the electricity to be consumed, at least in part, by the firearm accessory 902 of the firearm 900.

FIG. 2A depicts a side view of an embodiment of the solid-state generator 102, and an embodiment of a firearm 900.

Referring to the embodiments as depicted in FIG. 1 and FIG. 2A, the solid-state generator 102 is configured to be mounted (fixedly attached) to a barrel assembly 904 of the firearm 900, or configured to be mounted (fixedly attached) to an accessory rail 906 of the firearm 900. The solid-state generator 102 is configured to (in use) convert waste energy (such as, waste thermal energy and/or kinetic energy in the form of expanding gasses) created by the discharge of the firearm 900 into usable electricity (which may be consumed by, or provided to, a firearm accessory 902). The firearm accessory 902 may include (and is not limited to) an illuminated optic device, a light-emitting device, a laser-emitting device, etc., and any equivalent thereof. The firearm accessory 902 is normally powered by (configured to be powered by) an energy storage device 903. An embodiment of the energy storage device 903 includes (and is not limited to) a battery (known and not depicted) and/or a capacitor (in any combination thereof), and any equivalent thereof. The battery may include a chargeable battery or a non-chargeable battery (and any combination thereof). It will be appreciated and understood that the terms “energy storage device” and “battery” or “capacitor” may be used interchangeably in this document. The energy storage device 903 may be called electricity storage. The battery may include a lithium battery, a nickel cadmium battery, another variety, and any equivalent thereof. In accordance with a preferred embodiment, the solid-state generator 102 is configured to provide electricity to an energy storage device 903, and the energy storage device 903 is configured to provide electricity to the firearm accessory 902.

Without the utilization of the solid-state generator 102 (for charging the battery), the electricity contained in (stored in) the battery (which is associated with the firearm accessory 902) eventually becomes consumed or utilized (over time), and inconveniently the battery may (at some future time) no longer continue to provide electricity to power the firearm accessory 902.

With the utilization of the solid-state generator 102, the battery associated with the firearm accessory 902 may continue conveniently to operate for a relatively longer duration of time before the battery potentially becomes consumed (to the point where the battery may no longer continue to provide electricity to power the firearm accessory 902). In effect, the solid-state generator 102 extends the useful life (duty cycle) of the battery of the firearm accessory 902 (especially during important times when the firearm 900 is being utilized for critical tasks or life threatening situations).

For instance, the solid-state generator 102 may be advantageous for the case where the user (of the firearm 900) is a police officer or a soldier executing their tasks while on active duty (such as, apprehending criminals, or other dangerous life threatening situations, etc.). During active duty, the use may not be in a convenient place and/or time to replace a failed battery of the firearm accessory 902 (that is, once the battery becomes spent or consumed while the user is on active duty). In this case, the solid-state generator 102, in use, may extend the useful operating duration (life) of the battery so that the user (the police officer, or soldier) may carry on with their present dangerous duties without the potential interruption of a failed battery (that may inadvertently and inconveniently interfere with dangerous situations that may arise during the time of active duty of the user). Advantageously, the solid-state generator 102, in use, permits the user of the firearm accessory 902 (and the firearm 900) to continue using the firearm accessory 902 (and the firearm 900) for a relatively longer period of time (since the replacement of the battery of the firearm accessory 902 may then occur later rather than sooner, or the replacement or charging of the battery may be conveniently delayed for some future time when clear and present danger is no longer present for the user of the firearm 900).

Referring to the embodiments as depicted in FIG. 2A, the solid-state generator 102 is configured to convert, in use, the waste energy provided by (from) the firearm 900 into electricity (to be utilized in or stored in the battery associated with (connectable to) the firearm accessory 902). For instance, various ways (techniques) may be utilized for the conversion process, or for converting waste energy (associated with the discharging of the firearm 900) to electricity (such as and not limited to) converting the temperature difference between pressure-bearing components (such as, the barrel assembly 904) of the firearm 900 and the neighboring (adjacent) atmosphere into a usable voltage difference (as a result of the discharging of the firearm 900).

The solid-state generator 102 is configured to power (configured to provide electrical power to) the battery associated with the firearm accessory 902 (which represents an external power draw), whether the battery is positioned outside of the firearm accessory 902, or whether the battery is positioned within the firearm accessory 902. It will be appreciated that (in accordance with an embodiment) the solid-state generator 102 is configured to power (configured to provide electrical power to) the firearm accessory 902 (that represents an external power draw).

Body

In accordance with the embodiments as depicted in FIG. 2A, the body of the solid-state generator 102 is manufactured from (includes) a thermally-conductive body (material) configured to dissipate heat (thermal energy) into the immediate (adjacent) atmosphere. In accordance with an embodiment, the solid-state generator 102 may include (define or provide) lateral projections (heat-dissipating fins) having a relatively larger surface area to volume ratio (in order to increase the available surface area for heat transfer purposes). Preferably, the solid-state generator 102 includes heat-dissipating fins configured to promote heat transfer.

Electricity Management

In accordance with the embodiments as depicted in FIG. 1 and FIG. 2A, the solid-state generator 102 is configured to generate electricity from any type of waste energy conversion method. It will be appreciated that for some embodiments, the waste energy conversion method may produce a relatively small amount of direct current (DC power) for the battery. A way to mitigate this situation is to increase the voltage output of the solid-state generator 102 (in order for the DC power to be sufficient enough to charge the battery, or charge a capacitor, etc.). For instance, increasing the voltage output of the solid-state generator 102 may be accomplished with a voltage step-up transformer (known and not depicted), a high-efficiency boost converter (known and not depicted), a charger (known and not depicted) or any suitable method (and any equivalent thereof).

Electricity Generation

In accordance with the embodiments as depicted in FIG. 1 and FIG. 2A, the solid-state generator 102 may use, for instance, one of two methods (and any equivalent thereof), or a combination thereof, to convert the thermal waste energy and/or the waste kinetic energy into electricity.

In accordance with the embodiments as depicted in FIG. 1 and FIG. 2A, a first method includes a step for utilizing a temperature difference between (A) the surface that the solid-state generator 102 is mounted thereto, and (B) the ambient air (local environment). For the case where the firearm 900 is discharged, the barrel assembly 904 and other associated components may heat up (due to hot and expanding combustion gasses and friction resulting from the projectile exiting (departing from) the barrel assembly 904 of the firearm 900). Between the heat source and the heat sink assembly 202 there is positioned a pair of dissimilar semiconductors configured as a thermoelectric generator so that a temperature difference between the hot and cold sides will cause a voltage difference via the Seebeck effect (which are depicted in the embodiments of FIG. 4 and FIG. 5). The thermoelectric devices 200 (also called thermoelectric modules) are configured to generate electricity in response to the temperature difference between the body assembly 103 and heat sink assembly 202, in use, conveying the waste heat energy resulting from the discharging of the firearm 900. For the case where the barrel assembly 904 heats up, the temperature difference between the barrel assembly 904 and the heat sink assembly 202 creates a voltage difference across a thermoelectric device 200 (also called a thermoelectric generator); this process is known as the thermoelectric effect (also called the Seebeck effect). The thermoelectric process, in use, generates a relatively smaller voltage, which may be increased to charge the battery. The electricity generated by this method is direct current (DC electricity or DC voltage). The DC voltage is then amplified and stored in the battery (or a capacitor) where the battery may be used to provide electricity to the onboard or external load (such as to the firearm accessory 902).

FIG. 2A, FIG. 2B, and FIG. 3 to FIG. 6 depict the views for embodiments of the first type of the solid-state generator 102. FIG. 2A depicts a side view of an embodiment of the solid-state generator 102, and an embodiment of a firearm 900. FIG. 3 depicts a close-up of a side view of an embodiment of the solid-state generator 102 of FIG. 2A. FIG. 4 depicts a cross-sectional view of an embodiment of the solid-state generator 102 of FIG. 2A. The cross-sectional view is through line A-A, as depicted in FIG. 3. FIG. 5 depicts a perspective view of an embodiment of the solid-state generator 102 of FIG. 2A. FIG. 6 depicts an end view of an embodiment of the solid-state generator 102 of FIG. 2A.

Referring to the embodiments as depicted in FIG. 2A, FIG. 2B, and FIG. 3 to FIG. 6, in which the solid-state generator 102 includes (and is not limited to) a heat sink assembly 202 and a thermoelectric device 200 positioned proximate to the heat sink assembly 202 (embodiments are depicted in FIG. 4 and FIG. 5). The thermoelectric device 200 may be called a thermoelectric generator, a thermoelectric module, or thermoelectric generator module (and any equivalent thereof). The thermoelectric effect is the direct conversion of temperature differences to electric voltage, and vice versa. The thermoelectric device 200 is configured to create (generate) voltage when there is a different temperature on each side. Conversely, for the case where a voltage is applied to the thermoelectric device 200, the thermoelectric device 200 is shall (is configured to) create (generate) a temperature difference (in response to receiving an electrical charge). At the atomic scale, an applied temperature gradient causes charge carriers in the material to diffuse from the hot side to the cold side. The thermoelectric effect may be used to generate electricity, measure temperature or change the temperature of objects. Because the direction of heating and cooling is determined by the polarity of the applied voltage, the thermoelectric device 200 may be utilized as or with a temperature controller (known and not depicted), if so desired. For instance, the term “thermoelectric effect” encompasses (and is not limited to) these effects: (A) the Seebeck effect, (B) the Peltier effect, (C) the Thomson effect, and (D) Joule heating. The Seebeck effect and the Peltier effect are different manifestations of the same physical process (sometimes, these effects may be referred to as the Peltier-Seebeck effect). The Thomson effect is an extension of the Peltier-Seebeck effect. Joule heating, the heat that is generated whenever a current is passed through a resistive material, is related to the thermoelectric effect. The Peltier-Seebeck effect and the Thomson effect are thermodynamically reversible, whereas Joule heating is not thermodynamically reversible.

Referring to the embodiment as depicted in FIG. 2A (which depicts a side view), the solid-state generator 102 is securely positioned to a component of the firearm 900, and spaced apart from the firearm accessory 902 (the firearm accessory 902 is securely mounted to the firearm 900).

In accordance with the embodiment as depicted in FIG. 3, as a result of the discharging the firearm 900, the waste heat is converted into electricity as a result of the temperature difference between the thermoelectric device 200 and the heat sink assembly 202. The waste heat from the combustion of the propellant (as a result of the discharging the firearm 900) is transferred to the barrel assembly 904 of the firearm 900, where the waste heat (which originates in the interior of the barrel assembly 904) is converted into electricity as a result of the temperature difference between the solid-state generator 102 (which may include the thermoelectric device 200) and a heat sink assembly 202. Once the barrel assembly 904 is received in the interior passageway 212, the combustion gasses (resulting from the discharge of the firearm 900) may be directed through the interior passageway 212 of the solid-state generator 102, and the surface area of the interior passageway 212 is exposed to the flow of waste heat resulting from the discharge of the firearm 900. In summary, the thermoelectric device 200 is configured to convert the waste heat into electricity as a result of a temperature difference between the thermoelectric device 200 and the heat sink assembly 202 in response to the discharging the firearm 900.

Referring to the embodiment as depicted in FIG. 3 (which depicts a top view), the solid-state generator 102 is integrated with a component of the firearm 900.

Referring to the embodiments of as depicted in FIG. 4 and FIG. 5, the solid-state generator 102 and the firearm 900 may be integrated (housed in a single housing design, if so desired). For instance, the solid-state generator 102 and a component of the firearm 900 (such as, the barrel assembly 904) may be integrated, etc.

Referring to the embodiments of as depicted in FIG. 4 and FIG. 5, the body of the solid-state generator 102 is configured to provide a protective enclosure 213 (depicted in the embodiment of FIG. 4) for housing electronic components (known and not depicted), electricity storage (such as a battery, known and not depicted), and/or a means of attaching (such as, a clamp device) the solid-state generator 102 to the firearm 900, etc. The protective enclosure 213 is configured to securely receive and store the battery (the energy storage device 903), and/or to store and receive electronic components, and/or to provide a mounting surface for a switch and/or or other manual input (if so desired). In addition, the body of the solid-state generator 102 may include (also serve as) a handle 215, an accessory rail 906 (of the firearm 900) or other component for the case where the solid-state generator 102 is integrated into the firearm 900.

Referring to the embodiments as depicted in FIG. 4 (which depicts a cross-sectional view through cross-sectional line A-A of the embodiment of FIG. 3) and FIG. 5 (which depicts a perspective view of the embodiment of FIG. 3), the solid-state generator 102 is integrated with a component of the firearm 900. The solid-state generator 102 forms a part of the interior shaft of the barrel assembly 904. In accordance with an alternative embodiment, the solid-state generator 102 is attached to the barrel assembly 904 (or other component of the firearm 900). The solid-state generator 102 includes a thermoelectric device 200. Preferably, the thermoelectric device 200 includes a thermoelectric device 200 (also called a thermoelectric generator) which creates (is configured to create) a useable voltage difference. A heat sink assembly 202 is configured to receive and support the thermoelectric device 200.

Attachment

Referring to the embodiment as depicted in FIG. 6, the solid-state generator 102 may be configured (produced) in several configurations depending on the application (design requirements). The solid-state generator 102 is configured to be thermally coupled or connected (either directly or indirectly) to the barrel assembly 904 of the firearm 900. The solid-state generator 102 includes (involves) a clamp assembly 110 (depicted in FIG. 6). The clamp assembly 110 may be integrated into a body assembly 103 of the solid-state generator 102. For instance, the clamp assembly 110 is configured (designed) to attach the solid-state generator 102 to the accessory rail 906 (depicted in FIG. 2A) (or any suitable component) of the firearm 900. It will be appreciated that the solid-state generator 102 may also be configured to be integrated into the firearm 900 (by the manufacturer of the firearm 900, if so desired).

Referring to the embodiment as depicted in FIG. 6, a cross-sectional view of an embodiment of the solid-state generator 102 is depicted. The solid-state generator 102 is configured to be selectively fixedly attached (and removable from) a component of assembly of the firearm 900 (such as, the barrel assembly 904). Preferably, a clamp element 111 and a clamp assembly 110 are configured to selectively securely attach the solid-state generator 102 to the component of the firearm 900. The body assembly 103 of the solid-state generator 102 provides a thermally-conductive mating surface 105 configured to fit, at least in part, with the thermoelectric device 200. The solid-state generator 102 includes a heat sink assembly 202 configured to be coupled to the thermoelectric device 200.

FIG. 7 to FIG. 9 depict views of embodiments of the second type of the solid-state generator 102. FIG. 7 depicts a side view of an embodiment of the solid-state generator 102, and an embodiment of the firearm 900 of FIG. 2A. FIG. 8 depicts a close-up of a perspective view of an embodiment of the solid-state generator 102 of FIG. 7. FIG. 9 depicts a cross-sectional view of an embodiment of the solid-state generator 102 of FIG. 7. The cross-sectional view is taken along a cross-sectional line B-B of FIG. 8.

Referring to the embodiments as depicted in FIG. 7 to FIG. 9, the solid-state generator 102 includes (and is not limited to) a piezo-and-pyro electric device 300 (an embodiment is depicted in FIG. 9). The piezo-and-pyro electric device 300 is configured to respond to the combustion of a propellant, as a result of the discharge of the firearm 900 in such a way that the piezo-and-pyro electric device 300, in use, generates an output voltage.

Pyroelectricity is the property of certain crystals which are naturally electrically polarized and as a result contain large electrical fields, in which an example is the gallium nitride semiconductor. Alternatively, Pyroelectricity is interpreted as the ability of certain materials to generate a temporary voltage when they are heated or cooled. The change in temperature modifies the positions of the atoms slightly within the crystal structure, such that the polarization of the material changes. This polarization change gives rise to a voltage across the crystal. If the temperature stays constant at its new value, the pyroelectric voltage gradually disappears due to leakage current (the leakage can be due to electrons moving through the crystal, ions moving through the air, current leaking through a load attached across the crystal, etc.).

The hot gasses from the combustion of the propellant (as a result of the discharge of the firearm 900) are directed through the piezo-and-pyro electric device 300. This is done in such a way that (A) the pressure causes (urges or imposes) a strain force on the piezo-and-pyro electric device 300, and in response, the piezo-and-pyro electric device 300 (in use) generates or creates an output voltage, and/or (B) the temperature increase (as a result of the discharge of the firearm 900) urges the piezo-and-pyro electric device 300 to generate a voltage through the pyroelectric effect.

Referring to the embodiment as depicted in FIG. 7 (in which a side view is depicted), the solid-state generator 102 is configured to be selectively securely attached to the muzzle (an end section) of the barrel assembly 904.

Referring to the embodiment as depicted in FIG. 8 (in which a perspective view is depicted), the heat sink assembly 202 is mounted to or extends from the solid-state generator 102.

Referring to the embodiment as depicted in FIG. 9 (in which a cross-sectional view is depicted along cross-sectional line BB of FIG. 8), the piezo-and-pyro electric device 300 is securely mounted in the interior of the solid-state generator 102. The piezo-and-pyro electric device 300 is mounted to (within) a body assembly 103 (also called a housing assembly and any equivalent thereof) of the solid-state generator 102. The solid-state generator 102 is configured to be connectable (affixed) to and end portion (an exit) of the barrel assembly 904 (also depicted in FIG. 7). Alternatively, the body assembly 103 is configured to be connectable (affixed) to and end portion (an exit) of the barrel assembly 904 (with the solid-state generator 102 held by the body assembly 103.

The following is offered as further description of the embodiments, in which any one or more of any technical feature (described in the detailed description, the summary and the claims) may be combinable with any another one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to the disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus 100 (either explicitly or inherently). The apparatus 100 may include any suitable combination and/or permutation of the technical features as identified in the detailed description, as may be required and/or desired to suit a particular technical purpose and/or technical function. It will be appreciated that, where possible and suitable, any one or more of the technical features of the apparatus 100 may be combined with any other one or more of the technical features of the apparatus 100 (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus 100 to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transitory verb (transitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a solid-state generator configured to be coupled to, or to be integral to, a firearm configured to support a firearm accessory; and
the solid-state generator also configured to be electrically coupled to said firearm accessory, in which said firearm accessory is configured to be electrically powered; and
the solid-state generator also configured to convert, at least in part, waste energy generated, at least in part, by the discharge of said firearm into electricity in such a way that the solid-state generator, in use, provides, at least in part, the electricity to be consumed, at least in part, by said firearm accessory of said firearm.

2. The apparatus of claim 1, wherein:
the solid-state generator is configured to be fixedly attached to a barrel assembly of the firearm.

3. The apparatus of claim 1, wherein:
the solid-state generator is configured to be fixedly attached to an accessory rail of the firearm.

4. The apparatus of claim 1, wherein:
the solid-state generator is configured to provide electricity to an energy storage device; and
the energy storage device is configured to provide electricity to the firearm accessory.

5. The apparatus of claim 1, wherein:
the solid-state generator is configured to convert, in use, the waste energy produced by the firearm via a temperature difference between pressure-bearing components of the firearm and the adjacent atmosphere.

6. The apparatus of claim 1, wherein:
the solid-state generator and a component of the firearm are integrated.

7. The apparatus of claim 1, wherein:
the solid-state generator is configured to be thermally coupled to a barrel assembly of the firearm.

8. The apparatus of claim 1, wherein:
the solid-state generator includes:
a clamp assembly configured to attach the solid-state generator to a component of the firearm.

9. The apparatus of claim 1, wherein:
the solid-state generator includes;
a thermally-conductive body configured to dissipate thermal energy into the adjacent atmosphere.

10. The apparatus of claim 1, wherein:
the solid-state generator includes heat-dissipating fins configured to promote heat transfer.

11. The apparatus of claim 1, wherein:
the solid-state generator is configured to provide a protective enclosure for housing electronic components of the solid-state generator.

12. The apparatus of claim 1, wherein:
the solid-state generator includes:
a heat sink assembly; and
a thermoelectric device coupled to the heat sink assembly; and
the thermoelectric device is configured to generate electricity in response to a temperature difference between a body assembly and the heat sink assembly, in use, conveying the waste heat energy resulting from the discharging of the firearm.

13. The apparatus of claim 1, wherein:
the solid-state generator includes:
a heat sink assembly; and
a thermoelectric device positioned proximate to the heat sink assembly; and
the thermoelectric device is configured to convert the waste heat energy into electricity as a result of a temperature difference between the thermoelectric device and the heat sink assembly in response to the discharging the firearm.

14. The apparatus of claim 1, wherein:
the solid-state generator includes:
a thermoelectric device comprised of dissimilar semiconductors.

15. The apparatus of claim 1, wherein:
the solid-state generator includes:
a piezo-and-pyro electric device configured to respond to heat and pressure from the combustion of a propellant, as a result of the discharge of the firearm in such a way that the piezo-and-pyro electric device, in use, generates an output voltage.

16. An apparatus, comprising:
a firearm configured to support a firearm accessory; and
a solid-state generator configured to be coupled to, or to be integral to, the firearm; and
the solid-state generator also configured to be electrically coupled to said firearm accessory, in which said firearm accessory is configured to be electrically powered; and
the solid-state generator also configured to convert, at least in part, waste energy generated, at least in part, by the discharge of said firearm into electricity in such a way that the solid-state generator, in use, provides, at least in part, the electricity to be consumed, at least in part, by said firearm accessory of said firearm.

17. A method of operating a firearm accessory of a firearm, the method comprising:
converting, at least in part, waste energy generated, at least in part, by the discharge of said firearm into electricity; and
providing, at least in part, the electricity to be consumed, at least in part, by said firearm accessory of said firearm.
